(19) United States
(12) Patent Application Publication
(10) Pub. No.: US 2008/0105278 A1
(43) Pub. Date: May 8, 2008

(54) METHOD FOR VACUUM CLEANING

(75) Inventors: SANG BO KANG, INCHEON-SI (KR); IM SUK CHOI, INCHEON-SI (KR)

Correspondence Address: KNOBBE MARTENS OLSON & BEAR LLP, 2040 MAIN STREET, FOURTEENTH FLOOR, IRVINE, CA, 92614, US

(73) Assignee: DAEWOO ELECTRONICS CORPORATION, SEOUL (KR)

(21) Appl. No.: 11/935,170

(22) Filed: Nov. 5, 2007

(30) Foreign Application Priority Data
Nov. 3, 2006 (KR) 10-2006-0108288
Nov. 3, 2006 (KR) 10-2006-0108289
Nov. 3, 2006 (KR) 10-2006-0108290
Nov. 3, 2006 (KR) 10-2006-0108291
Nov. 3, 2006 (KR) 10-2006-0108292
Nov. 3, 2006 (KR) 10-2006-0108293
Nov. 3, 2006 (KR) 10-2006-0108294
Nov. 3, 2006 (KR) 10-2006-0108295

(51) Int. Cl. B08B 5/04

(52) U.S. Cl. 134/21

(57) ABSTRACT

Disclosed herein are a vacuum cleaner capable of being converted into a handy cleaner, and a handy cleaner-integrated vacuum cleaner. The vacuum cleaner includes a main body having a body inlet, a body outlet and a mounting part, and accommodating a motor assembly to induce air into the main body through the body inlet and then to discharge the air through the body outlet, and a dust container mounted on the mounting part to filter foreign matter from air which enters the main body through the body inlet; wherein the mounting part comprises a first mounting part on which the dust container is detachably mounted, and a second mounting part constituting an accommodation space. The handy cleaner-integrated vacuum cleaner includes an accommodation part formed on the main body to receive various kinds of nozzle, which will be connected to the body inlet.

### CROSS-REFERENCE TO RELATED PATENT APPLICATIONS

This application claims priority to and the benefit of Korean Patent Application Nos. 10-2006-0108288, filed Nov. 3, 2006, 10-2006-0108289, filed Nov. 3, 2006, 10-2006-0108290, filed Nov. 3, 2006, 10-2006-0108291, filed Nov. 3, 2006, 10-2006-0108292, filed Nov. 3, 2006, 10-2006-0108293, filed Nov. 3, 2006, 10-2006-0108294, filed Nov. 3, 2006, and 10-2006-0108295, filed Nov. 3, 2006, the disclosure of which are incorporated herein by reference in their entirety. This application is related to and incorporates herein by reference the entire contents of the following concurrently filed applications:

| | | | Application |
|---|---|---|---|
| Title | Atty. Docket No. | Filing Date | No. |
| VACUUM CLEANER | DWAJU.009AUS | | |
| HAND-HELD | DWAJU.011AUS | | |
| VACUUM CLEANER | | | |

### BACKGROUND

1. Field

The present disclosure relates to vacuum cleaner, and more particularly to operation of a vacuum cleaner incorporating components capable of forming a hand-held vacuum cleaner.

2. Discussion of the Related Technology

In general, vacuum cleaners can be classified in view of shapes and usage postures into a canister type vacuum cleaner, which is convenient in corner cleaning, movement and replacement of a brush or a nozzle, and an upright type vacuum cleaner, which is convenient in storage and cleaning of a large space.

FIG. 1 is a perspective view of an exemplary vacuum cleaner.

Referring to FIG. 1, the exemplary vacuum cleaner generally includes a suction unit 11 which is brought into close contact with a floor, a pipe 12 connected to the suction unit 11 and having a predetermined length, a handle 13 connected to the pipe 12, a hose 14 connected to the handle 13, and a body 20 connected to the handle 14.

The suction unit 11 is provided at a lower surface with wheels so that the suction unit 11 can be moved along with the body 20 for vacuuming operation, and the pipe 12 and handle 13 are used to manipulate and move the suction unit 11 to desired locations.

The pipe 12 and hose 14 serve to guide air containing foreign matter into the body 20, which in turn sucks the air containing the foreign matter and collects the foreign matter while discharging filtered air to an outside of the body 20.

FIG. 2 is a schematic cross-sectional view of the body shown in FIG. 1.

Referring to FIG. 2, the body 20 is provided at a front side with a hose attaching part 21 to which the hose 14 is coupled.

The body 20 has a dust collection unit 22 located in a central region of the body 20 and communicated with the hose attaching part 21.

In more detail, the dust collection unit 22 includes a dust container 24, which is inserted into an accommodation recess 23 defined in the central region of the body 20 and provided with a filter 25 to separate foreign matter from air.

The dust container 24 is provided at an upper side with a knob 26 and can be separated from the accommodation recess 23 by a separation button 27 formed on the knob 26.

A motor 28 is disposed adjacent the accommodation recess 23 inside the body 20 and driven by power supplied via a power cable 29.

When the motor 28 is driven, air containing foreign matter is drawn into the dust container 24 and passes through the filter 25 in the dust container 24, so the foreign matter is filtered by the filter 25 and collected in the container 24 while filtered air is discharged outside the vacuum cleaner.

Then, when filled with the foreign matter, the dust container 24 is pulled out of the accommodation recess 23 by pushing the separation button 27, and opened to remove the foreign matter by means of a separate button (not shown).

The foregoing discussion is to provide general background information, and does not constitute an admission of prior art

### SUMMARY

One aspect of the invention provides a vacuum cleaner apparatus, which comprise: a main body comprising a first mounting station and a first suction source; a first member releasably secured to the main body on the first mounting station, wherein the first member comprising a first housing and a dust container, which is defined by or enclosed in the first housing; a second member comprising a second housing and a second suction source enclosed in the second housing; wherein when released from the main body, the first member is capable of forming an operable vacuum cleaning connection with the second member so as to provide a handheld vacuum cleaner; and wherein when secured to the main body, the first member does not form an operable vacuum cleaning connection with the second member and rather forms an operable vacuum cleaning connection with the first suction source so as to provide another vacuum cleaner.

In the foregoing apparatus, the main body may further comprise a second mounting station formed on the main housing, wherein the second member is releasably secured to the main body. The main body may not comprise a mounting station to secure the second member. The first housing may comprise a first inlet and a first outlet in fluid communication with the dust container. The main body may comprise a first suction passage and a second suction passage, wherein when the first member is secured to the main body, the first suction passage may be in fluid communication with the dust container via the first inlet, and the first suction source and the first outlet are in fluid communication via the second suction passage. The first housing may comprise a first wall, and the main body may comprise a second wall, wherein the first wall and the second wall may oppose and contact each other, wherein the first inlet and the first outlet may be formed through the first wall. The second suction passage may have an opening formed through the second wall of the main body, wherein the first outlet may be configured to engage with the opening of the second suction passage so as to permit an airflow from the dust container to the first suction source via the second suction passage.

Still in the foregoing apparatus, the second housing may comprise a second inlet and a second outlet, wherein the second suction source is configured to create a forced airflow from the second inlet to the second outlet. When the first and second members form the handheld vacuum cleaner, the first outlet may be engaged with the second inlet. The first housing may define an airflow path between the first inlet and the first outlet, wherein the apparatus may further comprise a filter in the airflow path such that air flowing into the first housing via the first inlet is filtered by the filter prior to being discharged from the first housing via the first outlet. The first housing may define an airflow path between the first inlet and the first outlet, wherein the airflow path may be configured to generate a swirling airflow as air flows therethrough.

Yet in the foregoing apparatus, the other vacuum cleaner may be a canister type vacuum cleaner. At least one of the first and second members may further comprise a rechargeable battery. The apparatus may further comprise a battery charging station in the main body and configured to connect to the rechargeable battery. The first member may be configured to be secured to and released from the main body without use of a tool. The first member may further comprise a handle of the handheld vacuum cleaner. The main body may further define a compartment configured to receive at least one selected from the group consisting of nozzles and extension tubes.

Further in the foregoing apparatus, the apparatus may further comprise an air intake tube connected to the second housing, wherein the air intake tube may be configured to initially receive outside air and guide the air to a conduit defined in the second housing, wherein when the first and second members form the handheld vacuum cleaner, the conduit of the second handheld housing may interconnect between the air intake tube and the first housing such that outside air is initially received by the air intake tube and travels to the first housing via the conduit of the second housing. The air intake tube may be configured to hingedly move relative to the second member between a first position and a second position, wherein the air intake tube may be in fluid communication with the conduit in the first position, and wherein the air intake tube may be not in fluid communication with the conduit in the second position. The main body may further comprise a second mounting station, wherein the second member may be releasably secured to the main body, wherein the air intake tube may be in the second position when the second member is secured to the main body.

Another aspect of the invention provides a method of vacuum cleaning, which comprises: providing a vacuum cleaner device comprising a main body, a first member releasably secured to the main body, a second member releasably secured to the main body, and a suction hose connected to the main body, wherein the main body comprises a first suction source, wherein the first member comprises a first housing and a dust container defined by or enclosed in the first housing, wherein the dust container is in fluid communication with the first suction source, wherein the second member comprises a second housing and a second suction source enclosed in the second housing, wherein the dust container is not in fluid communication with the second suction source, wherein the suction hose is in fluid communication with the dust container of the first member; and running the first suction source so as to create a negative pressure in the dust container and in the suction hose, thereby cleaning a surface.

In the foregoing method, the method may further comprise: releasing the first member from the main body; releasing the second member from the main body; and engaging the first housing and the second housing to assemble a handheld vacuum cleaner such that the dust container and the second suction source are in fluid communication. The handheld vacuum cleaner may comprise an air intake tube in fluid communication with the dust container, wherein the method may further comprise running the second suction source so as to create airflows from the air intake tube to the dust container and from the dust container to the suction source, thereby cleaning a surface. Outside air may be drawn into the air intake tube and flow to the dust container generally in a first direction, wherein air in the dust container may flow to the suction source generally in a second direction, which crosses the first direction when viewed from the top of the handheld vacuum cleaner. The first and second directions may cross at about a right angle. The second housing may define a conduit interconnecting between the air intake tube and the dust container of the first member, wherein the outside air drawn into the air intake tube flows through the conduit of the second housing to reach the dust container. The air intake tube may be hingedly connected to the second housing, and wherein the method may further comprise hingedly rotating the air intake tube between a first position and a second position.

In the foregoing method, the first member may be released from the main body without use of a tool. The method may further comprise: disengaging the first member from the second member; securing the first member to the main body such the dust container may be in fluid communication with the first suction source; and securing the second member to the main body. Securing the first member to the main body does not require a tool. The main body may further comprise a storage compartment and may further comprise at least one of a nozzle and an extension tube stored in the storage compartment, wherein the method may further comprise connecting at least one of the nozzle and the extension tube to the suction hose. The vacuum cleaner device may be a canister type vacuum cleaner. The first member may comprise partitioning walls configured to generate a swirling airflow within the dust container. The first housing may comprise a first inlet and a first outlet, wherein the dust container may be positioned in a path between the first inlet and the first outlet, wherein the main body may comprise a first suction passage and a second suction passage, wherein the first suction passage may be in fluid communication with the dust container via the first inlet, and the first suction source and the first outlet are in fluid communication via the second suction passage.

Another aspect of the invention provides a method of vacuum cleaning. The method comprises: providing a first member comprising a first housing and a dust container defined by or enclosed in the first housing; providing a second member comprising a second housing and a suction source enclosed in the second housing; engaging the first and second members so as to form a single body handheld vacuum cleaner, in which the dust container and the suction source are in fluid communication with each other, wherein the handheld vacuum cleaner comprises an air intake tube in fluid communication with the dust container; and running the suction source so as to create airflows from the air intake tube to the dust container and from the dust container to the suction source, wherein outside air is drawn into the air intake tube and flows to the dust container generally in a first direction, wherein air in the dust container flows to the suction source generally in a second direction, which crosses the first direction when viewed from the top of the handheld vacuum cleaner.

In the foregoing method, the first and second direction may cross at about a right angle. The handheld vacuum cleaner may further comprise an elongated handle, wherein when viewed from the top, the first housing may be generally on one side of the elongated handle and the second housing may be generally on the other side of the elongated handle. The elongated handle may be fixed to the first housing. The second housing may define a conduit interconnecting between the air intake tube and the dust container of the first member, wherein the outside air drawn into the air intake tube may flow through the conduit of the second housing to reach the dust container. The first member may comprise partitioning walls configured to generate a swirling airflow within the dust container.

Another aspect of the invention provides a hand-held vacuum cleaner device. The device comprises: a first member comprising a first housing and a dust container defined by or enclosed in the first housing; a second member comprising a second housing and a suction source enclosed in the second housing, wherein the first and second housings are engaged with each other to form a single body handheld vacuum cleaner; an air intake tube configured to initially receive outside air, wherein the air intake tube is in fluid communication with the first housing, wherein a first airflow is to be formed via the air intake tube to the dust container when the suction source is operating; and wherein the first and second members are arranged such that a second airflow is to be formed from the first housing to the second housing when the suction source is operating, wherein directions of the first and second airflows generally cross each other when viewed from the top of the handheld vacuum cleaner.

The foregoing device may further comprise an elongated handle of the handheld vacuum cleaner, and wherein when viewed from the top, the first member may be generally on one side of the elongated handle and the second member may be generally on the other side of the elongated handle. The elongated handle may be fixed to the first housing. The directions of the first and second air may flow may cross each other at about a right angle. The directions of the first and second air may flow may cross each other at an angle other than a right angle. The first member may comprise a first inlet and a first outlet formed in the first housing, wherein the first inlet may be configured to receive the first airflow. The second member may comprise a second inlet and a second outlet formed in the second housing, wherein the second inlet and the first outlet may be engaged so as to permit the second airflow from the first housing to the second housing, and wherein the second member may be configured to discharge air reaching the suction source through the second outlet. The second inlet and outlet may be substantially opposingly positioned in the second housing. The second member may further comprise a conduit provided in the second housing and interconnecting between the air intake tube and the first inlet of the first member.

In the foregoing device, the first housing may define an internal airflow path between the first inlet and the first outlet, wherein the internal airflow path may be configured to generate a swirling airflow therethrough. The first housing may define an internal airflow path between the first inlet and the first outlet, wherein the device may further comprise a filter in the internal airflow path such that air flowing into the first housing via the first inlet may be filtered by the filter prior to being discharged from the first housing via the first outlet. The first housing may comprise a first wall, and the second housing may comprise a second wall, wherein the first wall and the second wall may oppose and contact each other, wherein the first inlet and the first outlet are formed through the first wall. The second member may comprise a second inlet formed in the second housing and configured to engage with the first outlet so as to permit the second airflow from the first housing to the second housing, wherein the second inlet may be formed through the second wall. The second member may further comprise a conduit provided in the second housing, wherein the conduit may have a first opening through the second wall, wherein the opening of the conduit may be positioned to engage with the first inlet. The conduit has a second opening connected to the air intake tube, wherein the first airflow may be configured to made to the dust container through the air intake tube, the second opening, the conduit, the first opening, and the first inlet in order. The device may further comprise a rechargeable battery housed in either the first housing or the second housing.

Another aspect of the invention provides a hand-held vacuum cleaner device. The device comprises: a first member comprising a first housing and a dust container defined by or enclosed in the first housing; a second member comprising a second housing and a suction source enclosed in the second housing, wherein the first and second housings are engaged with each other to form a single body handheld vacuum cleaner; and an air intake tube hingedly connected to the first member or the second member, and configured to hingedly rotate between a first position and a second position, wherein in the first position the air intake tube is in full fluid communication with the dust container, wherein in the second position the air intake tube is substantially not in fluid communication with the dust container. The second member may comprise a conduit formed in the second housing, wherein the conduit interconnects between the air intake tube and the dust container. The air intake tube may comprise a distal end, wherein in the first position the distal end may be at a first distance, wherein in the second position the distal end may be at a second distance, and wherein the second distance may be greater than the first distance. The device may further comprise an elongated handle of the handheld vacuum cleaner, and wherein when viewed from the top, the first member may be generally on one side of the elongated handle and the second member may be generally on the other side of the elongated handle.

An aspect of the present invention is to provide a vacuum cleaner that has an improved dust container-mounting structure to allow a convenient conversion into a handy cleaner through convenient mounting of a dust container, while allowing an efficient flow of air in the vacuum cleaner.

Another aspect of the present invention provides a vacuum cleaner that has a handy cleaner integrated thereto so as to allow vacuum cleaning without a separate handy cleaner even in a narrow space or a place where a power source cannot be provided, and that is configured to allow convenient accommodation of various components for vacuuming operation.

An aspect of the present invention provides a vacuum cleaner includes: a main body having a body inlet, a body outlet and a mounting part, and accommodating a motor assembly to induce air into the main body through the body inlet and then to discharge the air through the body outlet; and a dust container mounted on the mounting part to filter foreign matter from air which enters the main body through the body inlet; wherein the mounting part comprises a first mounting part on which the dust container is mounted, and a second mounting part constituting an accommodation space.

Preferably, the body inlet is formed on a front portion of the main body, the body outlet is formed on a rear portion of the main body, and the motor assembly is located near the body outlet.

Preferably, the dust container includes a case; a cover provided to the case, and having an intake port and an exhaust port formed thereon; and a filter disposed at one side of the exhaust port.

Preferably, the vacuum cleaner further includes a mounting device comprising a first mounting device provided to the dust container, and a second mounting device provided to the first mounting part and coupled to the first mounting device.

Preferably, the first mounting device is provided to a knob disposed on the cover and a knob-cover provided to the knob to constitute a predetermined space.

Preferably, the first mounting part includes a discharge port corresponding to the intake port to communicate with the body inlet, and a suction port corresponding to the exhaust port to communicate with the body outlet.

Preferably, the vacuum cleaner further includes a curved guide duct provided to the intake port and extending to one side of the filter.

Preferably, the first mounting device includes a latch protrusion configured to be inserted into or protrude from the cover, a knob-button movably provided to the knob to allow the latch protrusion to be inserted into the cover when being pushed, and an elastic member disposed between the latch protrusion and an inner wall of the knob to apply to force the latch protrusion, and the second mounting device includes a groove formed corresponding to the latch protrusion on the first mounting part.

Preferably, the vacuum cleaner further includes a connection device provided to the exhaust port and the suction port.

Preferably, the connection device includes a circular jaw extending outward from a periphery of the exhaust port, a sliding protrusion protruding from an end of the jaw in a lateral direction, a circular insertion groove formed corresponding to the jaw around a periphery of the suction port, a catch protrusion formed at an outer end of the insertion groove to catch the sliding protrusion, and a sealing member of an elastic material fitted into the insertion groove.

Another aspect of the present invention provides a handy cleaner-integrated vacuum cleaner includes: a main body having a body inlet, a body outlet and a mounting part, and accommodating a motor assembly to induce air into the main body through the body inlet and then to discharge the air through the body outlet; a dust container mounted on the mounting part to filter foreign matter from air which enters the main body through the body inlet; a driving unit mounted on the mounting part and generating a suction force in the dust container when being coupled to the dust container; and an accommodation part provided on the main body to accommodate a nozzle connected to the body inlet.

Preferably, the accommodation part is formed on a lower surface of the main body.

Preferably, the accommodation part has an accommodation groove formed corresponding to a shape of the nozzle on an inner wall of the accommodation part.

Preferably, the accommodation part is provided with a lid, and an opening-closing device is provided to the accommodation part and the lid.

Preferably, the opening-closing device includes a hook protrusion formed on the lid, and a fastening groove formed on the accommodation part such that the hook protrusion is fitted into the fastening groove.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is a perspective view of a conventional vacuum cleaner;

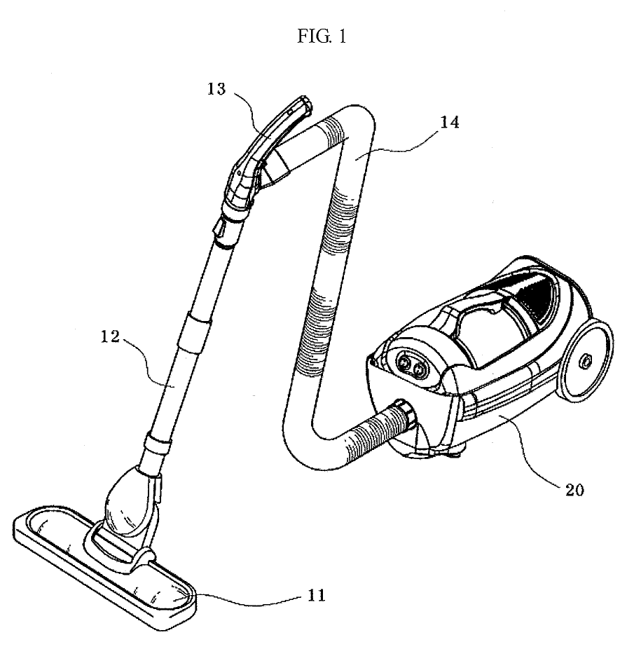

FIG. 2 is a schematic cross-sectional view of a body of the conventional vacuum cleaner shown in FIG. 1;

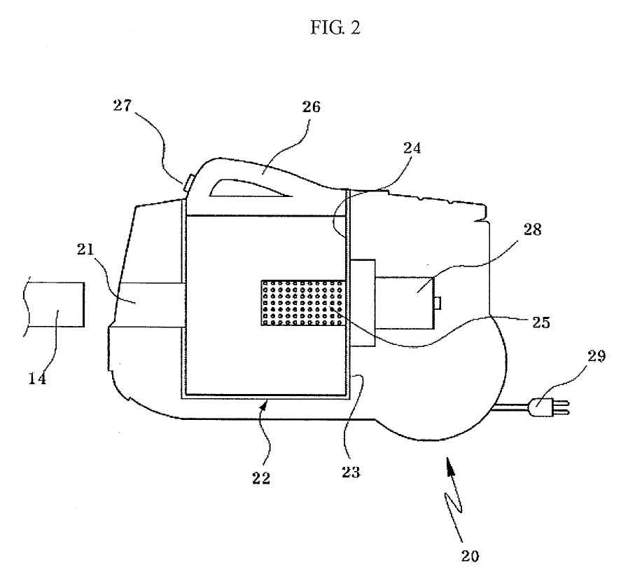

FIG. 3 is a perspective view of a handy cleaner-integrated vacuum cleaner according to an embodiment of the present invention

FIG. 4 is a perspective view of a main body of the handy cleaner-integrated vacuum cleaner according to an embodiment of the present invention;

FIG. 5 is an exploded perspective view of a handy cleaner of the handy cleaner-integrated vacuum cleaner according to an embodiment of the present invention;

FIG. 6 is a plan view of the handy cleaner-integrated vacuum cleaner according to an embodiment of the present invention;

FIG. 7 is a cross-sectional view taken along line A-A of FIG. 6, illustrating a suction path of the handy cleaner-integrated vacuum cleaner;

FIG. 8 is a side view of the handy cleaner-integrated vacuum cleaner according to an embodiment of the present invention;

FIG. 9 is a cross-sectional view taken along line B-B of FIG. 8, illustrating a discharge path of the handy cleaner-integrated vacuum cleaner;

FIG. 10 is a perspective view of the handy cleaner of the handy cleaner-integrated vacuum cleaner according to an embodiment of the present invention;

FIG. 11 is an exploded perspective view of a dust container of the handy cleaner-integrated vacuum cleaner according to an embodiment of the present invention;

FIG. 12 is a plan view of the handy cleaner of the handy cleaner-integrated vacuum cleaner according to an embodiment of the present invention;

FIG. 13 is a cross-sectional view taken along line C-C of FIG. 12, illustrating a suction path of the handy cleaner;

FIG. 14 is a side iew of the handy cleaner of the handy cleaner-integrated vacuum cleaner according to an embodiment of the present invention;

FIG. 15 is a cross-sectional view taken along line D-D of FIG. 14, illustrating a discharge path of the handy cleaner;

FIG. 16 is a bottom perspective view of a driving unit of the handy cleaner-integrated vacuum cleaner according to an embodiment of the present invention;

FIG. 17 is a cross-sectional view of a power supply device of the handy cleaner-integrated vacuum cleaner according to an embodiment of the present invention;

FIG. 18 is an exploded cross-sectional view of the power supply device of the vacuum cleaner according to an embodiment of the present invention;

FIG. 19 is a perspective view of the power supply device of the handy cleaner-integrated vacuum cleaner according to an embodiment of the present invention;

FIG. 20 is an exploded cross-sectional view of the power supply device of the handy cleaner-integrated vacuum cleaner according to an embodiment of the present invention;

FIG. 21 is a side sectional view of the power supply device of the handy cleaner-integrated vacuum cleaner according to an embodiment of the present invention;

FIG. 22 is a perspective view of a connection device of the handy cleaner-integrated vacuum cleaner according to an embodiment of the present invention;

FIG. 23 is a perspective view of an accommodation part of the handy cleaner-integrated vacuum cleaner according to an embodiment of the present invention;

FIG. 24 is a cross-sectional view of the accommodation part of the handy cleaner-integrated vacuum cleaner according to an embodiment of the present invention; and

FIG. 25 is a schematic view of the power supply device of the handy cleaner-integrated vacuum cleaner according to an embodiment of the present invention.

### DETAILED DESCRIPTION OF EMBODIMENTS

Various embodiments of the present invention will be described in detail with reference to the accompanying drawings hereinafter.

For convenience of description, a handy cleaner-integrated vacuum cleaner will be described by way of examples. Here, it should be noted that the drawings are not to precise scale and may be exaggerated in thickness of lines or size of components for descriptive convenience and clarity only.

Furthermore, terms used herein are defined by taking functions of the present invention into account and can be changed according to the custom or intention of users or operators.

Therefore, definition of the terms should be made according to overall disclosures herein.

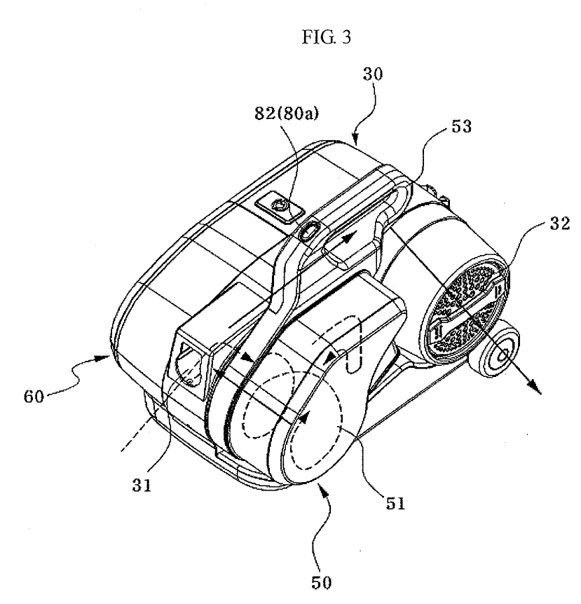

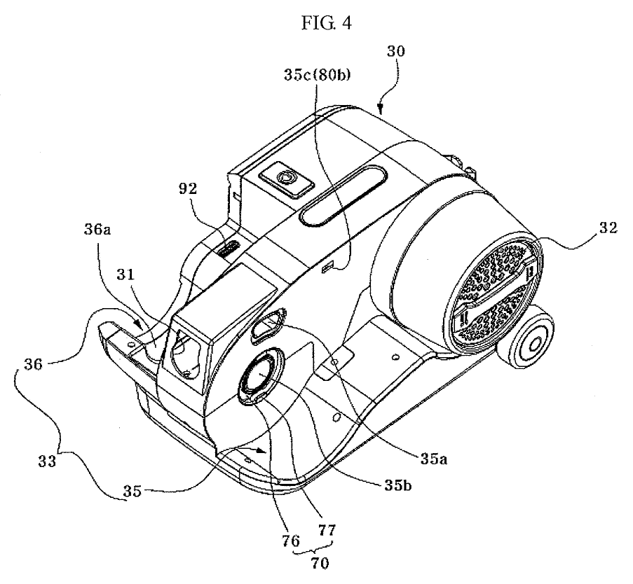

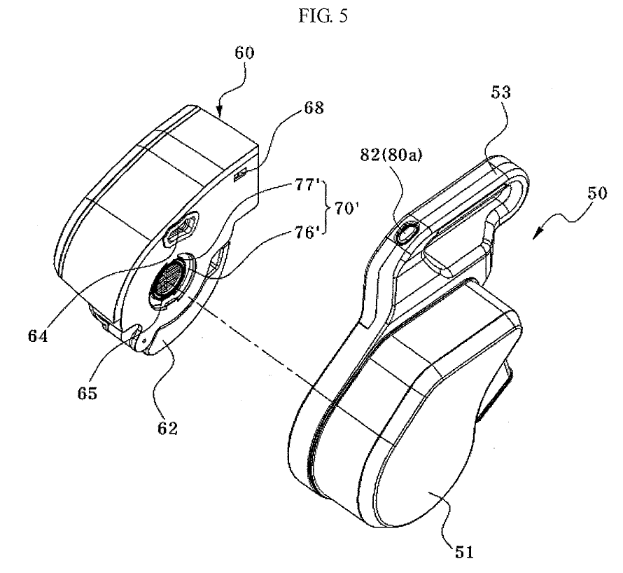

FIG. 3 is a perspective view of a vacuum cleaner having a handy cleaner according to an embodiment of the present invention; FIG. 4 is a perspective view of a main body of the handy cleaner-integrated vacuum cleaner according to an embodiment of the present invention; and FIG. 5 is an exploded perspective view of a handy cleaner of the handy cleaner-integrated vacuum cleaner according to an embodiment of the present invention.

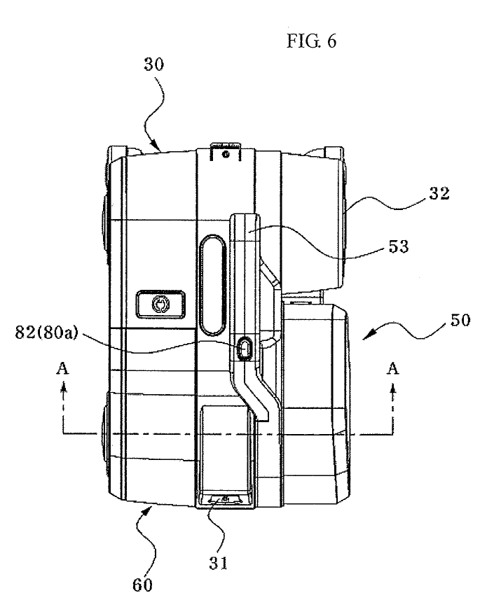

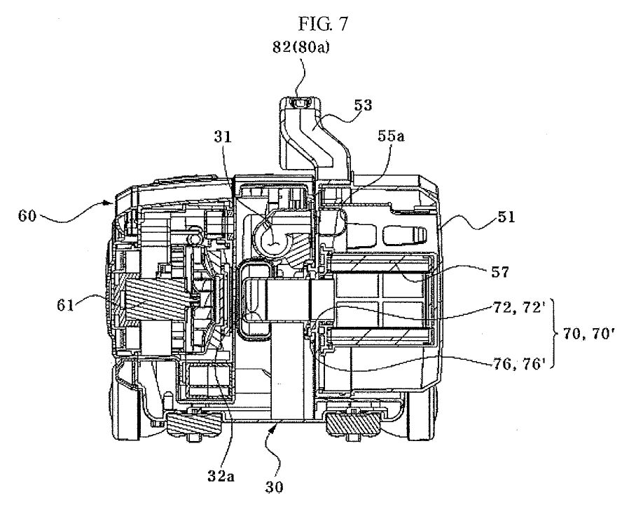

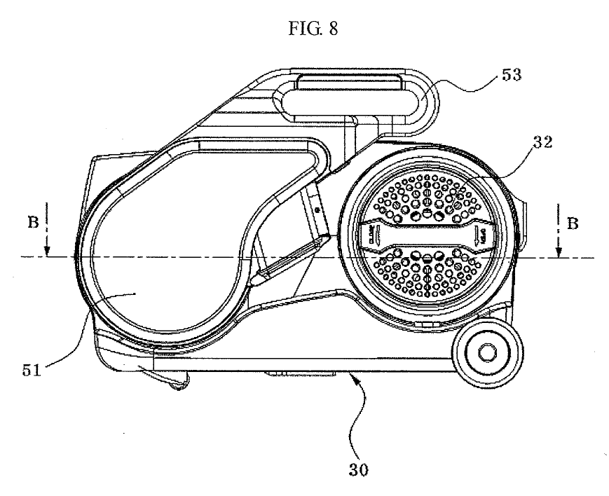

FIG. 6 is a plan view of the handy cleaner-integrated vacuum cleaner according to an embodiment of the present invention; FIG. 7 is a cross-sectional view taken along line A-A of FIG. 6, illustrating a suction path of the handy cleaner-integrated vacuum cleaner; and FIG. 8 is a side view of the handy cleaner-integrated vacuum cleaner according to an embodiment of the present invention.

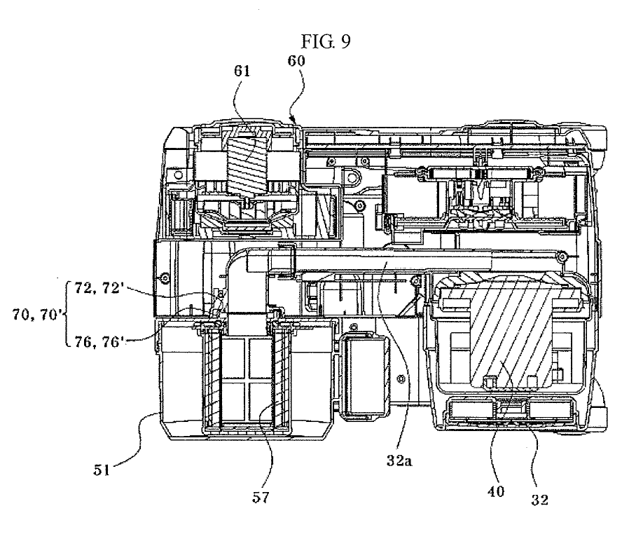

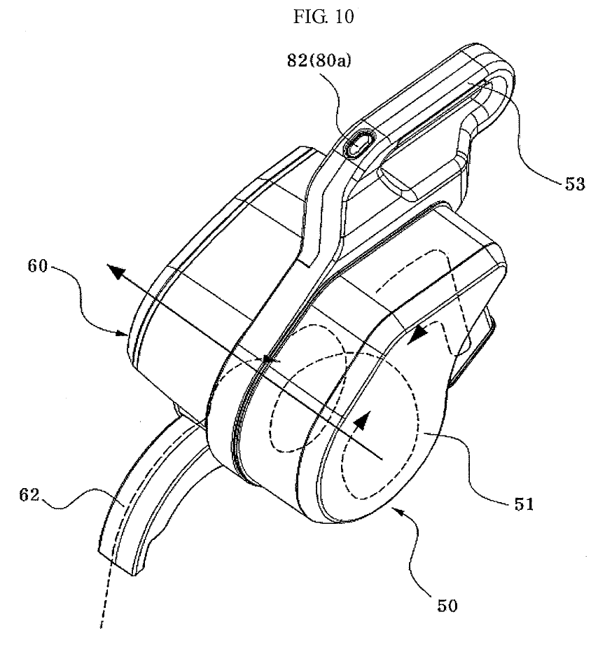

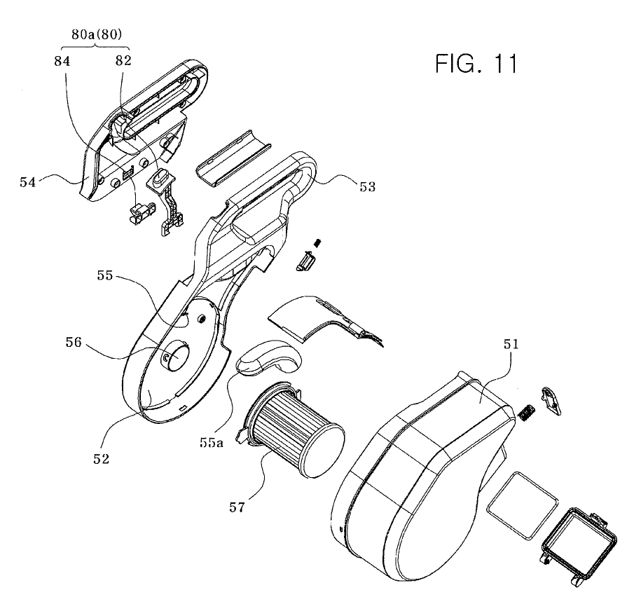

FIG. 9 is a cross-sectional view taken along line B-B of FIG. 8, illustrating a discharge path of the handy cleaner-integrated vacuum cleaner; FIG. 10 is a perspective view of the handy cleaner of the handy cleaner-integrated vacuum cleaner according to an embodiment of the present invention; and FIG. 11 is an exploded perspective view of a dust container of the handy cleaner-integrated vacuum cleaner according to an embodiment of the present invention.

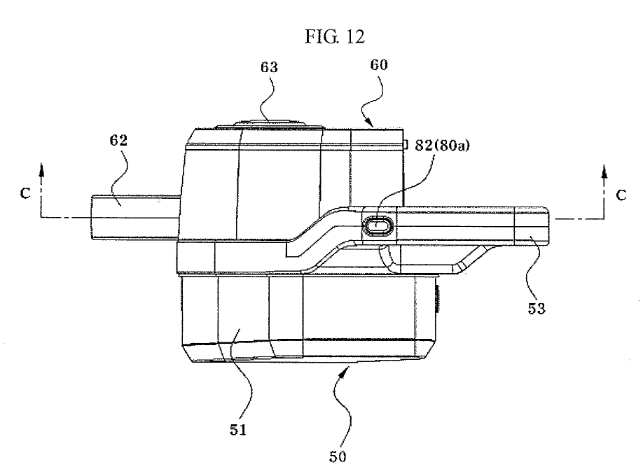

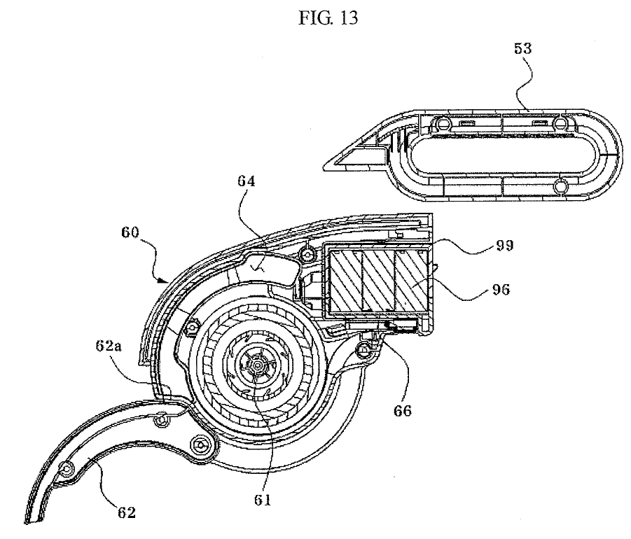

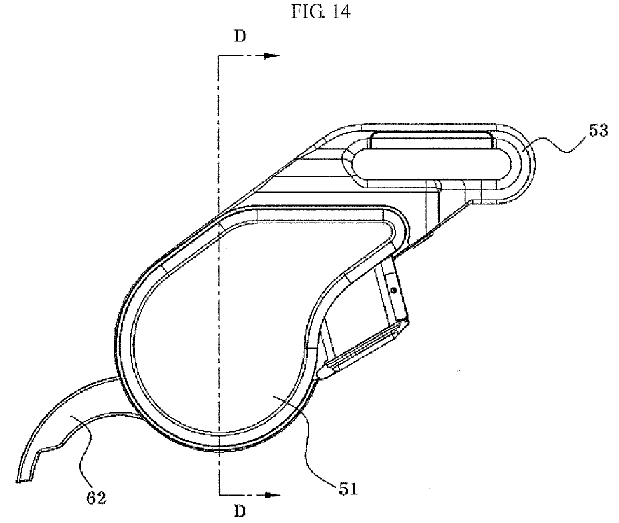

FIG. 12 is a plan view of the handy cleaner of the handy cleaner-integrated vacuum cleaner according to an embodiment of the present invention; FIG. 13 is a cross-sectional view taken along line C-C of FIG. 12, illustrating a suction path of the handy cleaner; and FIG. 14 is a side view of the handy cleaner of the handy cleaner-integrated vacuum cleaner according to an embodiment of the present invention.

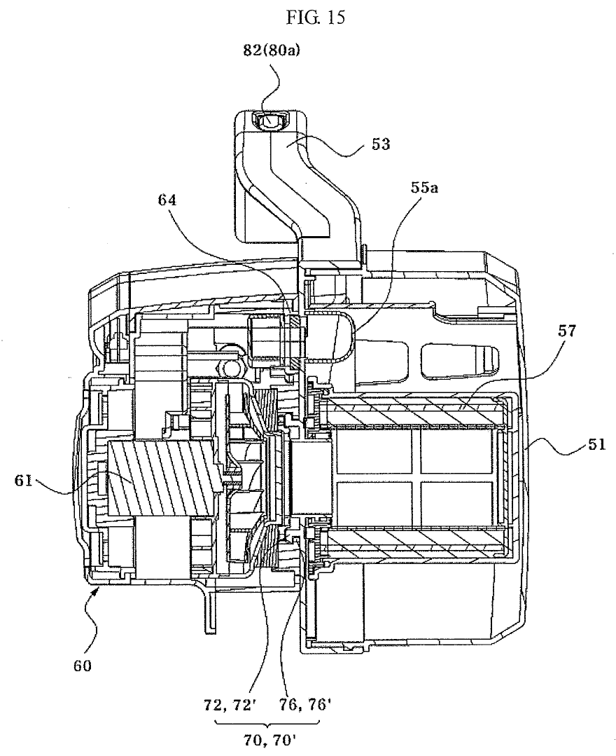

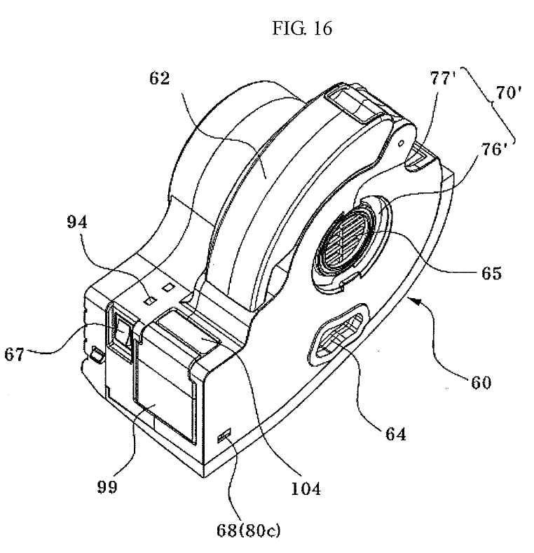

FIG. 15 is a cross-sectional view taken along line D-D of FIG. 14, illustrating a discharge path of the handy cleaner; FIG. 16 is a bottom perspective view of a driving unit of the handy cleaner-integrated vacuum cleaner according to an embodiment of the present invention; and

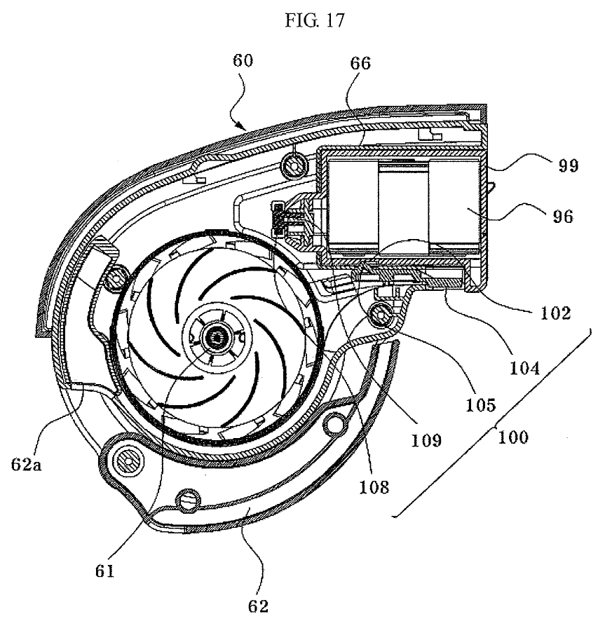

FIG. 17 is a cross-sectional view of a power supply device of the handy cleaner-integrated vacuum cleaner according to an embodiment of the present invention.

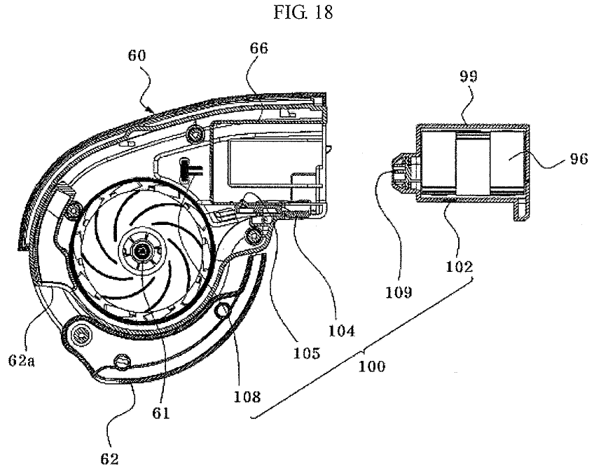

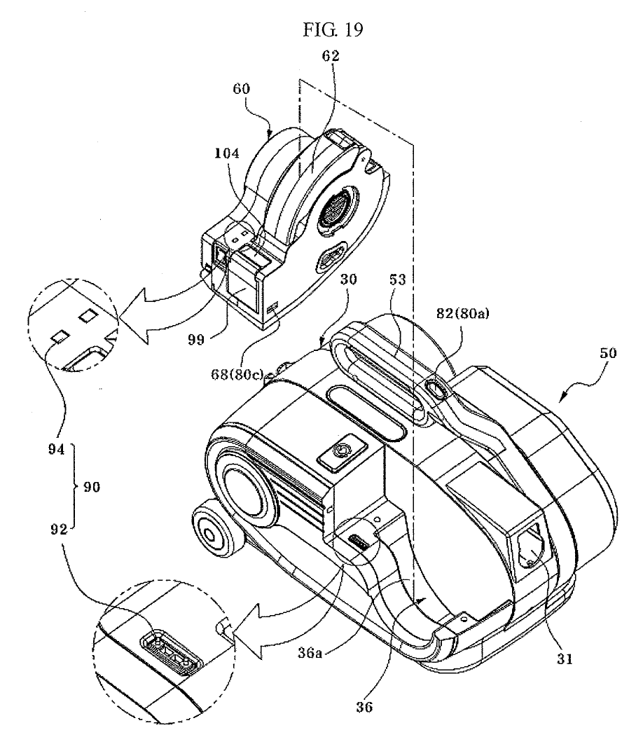

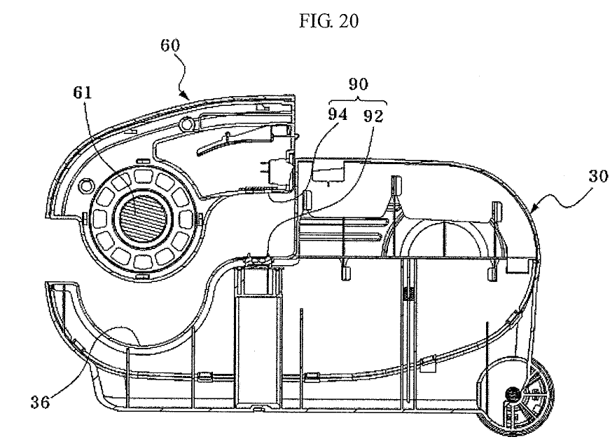

FIG. 18 is an exploded cross-sectional view of the power supply device of the vacuum cleaner according to an embodiment of the present invention; FIG. 19 is a perspective view of the power supply device of the vacuum cleaner according to an embodiment of the present invention; and FIG. 20 is an exploded cross-sectional view of the power supply device of the vacuum cleaner according to an embodiment of the present invention.

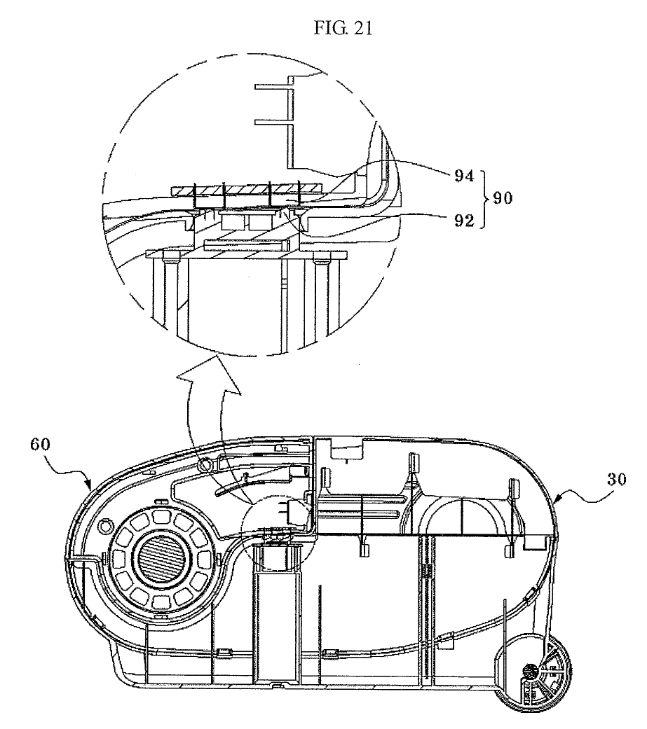

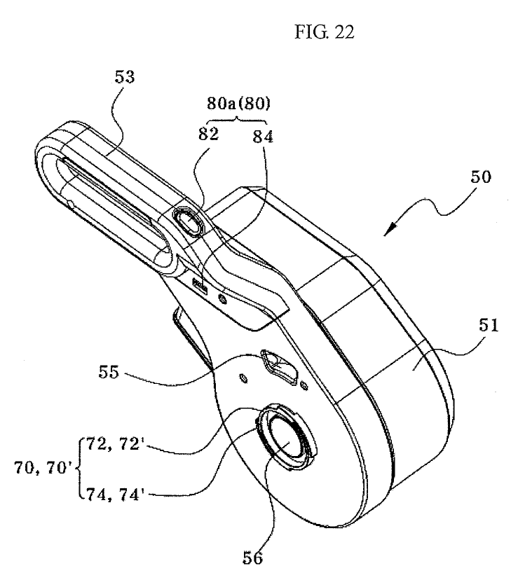

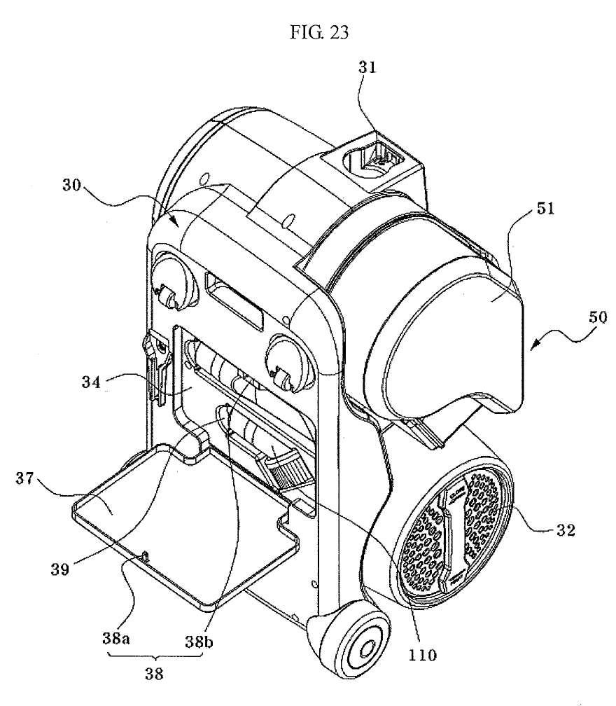

FIG. 21 is a side sectional view of the power supply device of the handy cleaner-integrated vacuum cleaner according to an embodiment of the present invention; FIG. 22 is a perspective view of a connection device of the handy cleaner-integrated vacuum cleaner according to an embodiment of the present invention; and FIG. 23 is a perspective view of an accommodation part of the handy cleaner-integrated vacuum cleaner according to an embodiment of the present invention.

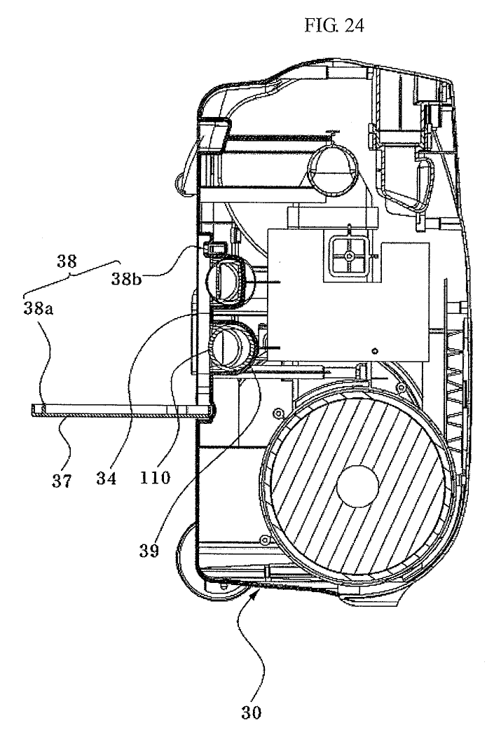

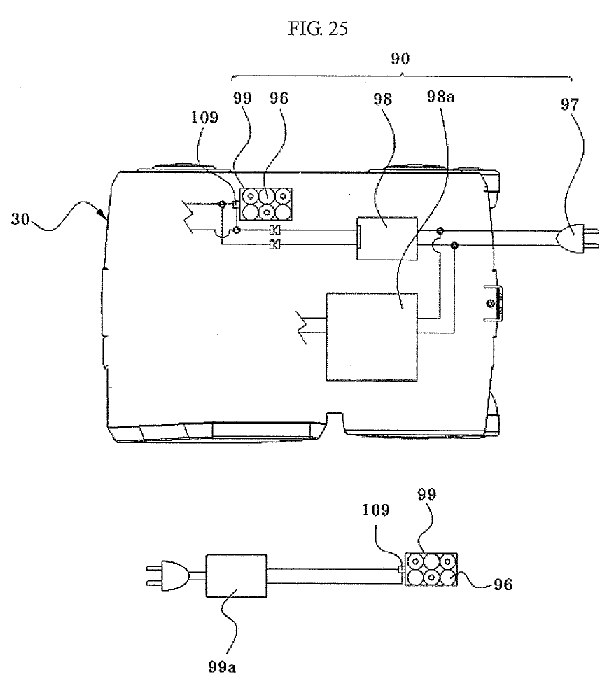

FIG. 24 is a cross-sectional view of the accommodation part of the handy cleaner-integrated vacuum cleaner according to an embodiment of the present invention; and FIG. 25 is a schematic view of the power supply device of the handy cleaner-integrated vacuum cleaner according to an embodiment of the present invention.

Referring to FIGS. 3 to 9, the vacuum cleaner according to an embodiment of the invention includes a main body 30 having a body inlet 31, a body outlet 32, and a mounting part 33 formed thereon; a motor assembly 40 (see FIG. 9) disposed in the main body 30 to force air induced into the main body 30 through the body inlet 31 to be discharged outside through the body outlet 32; a dust container 50 detachably mounted on the mounting part 33 to filter foreign matter from air which enters the main body 30 through the body inlet 31; a driving unit 60 detachably mounted on the mounting part 33 and coupled to the dust container 50 to generate a suction force in the dust container 50 when the dust container 50 is detached from the main body 30; and a power supply device 90 (see FIG. 19) provided to the main body 30 and the driving unit 60.

When power is supplied to the vacuum cleaner with the dust container 50 and the driving unit 60 mounted on the main body 30, the motor assembly 40 is driven to force air to be induced into the main body 30 through a nozzle 110 via an extension duct (not shown) connected to the body inlet 31.

Then, with foreign matter separated from air in the dust container 50, air is discharged to the outside through the body outlet 32, thereby enabling a vacuuming operation of the vacuum cleaner.

Electrical power is stored in the driving unit 60 via the power supply device 90. Thus, with the dust container 50 and the driving unit 60 separated from the main body 30 and coupled to each other, the driving unit 60 can be operated by turning on a power switch 67, enabling a vacuuming operation of a handy cleaner.

Here, since a principle of storing the electrical power in the driving unit 60 via the power supply device 90 is the same as that of a typical recharger, a detailed description thereof will be omitted herein.

The body inlet 31 is formed at a front central region of the main body 30, and the body outlet 32 is formed at one side on the rear of the main body 30. The motor assembly 40 is located inside the body outlet 32.

The mounting part 33 includes a fist mounting part 35 depressed on one side of the main body 30 with respect to the center of the main body 30, and a second mounting part 36 depressed on the other side of the main body 30.

After being induced into the main body 30 through the body inlet 31, air is removed of foreign matter while passing through the dust container 50 mounted on the first mounting part 35, and is then discharged to the outside through the body outlet 32 by the motor assembly 40.

Referring to FIGS. 10 to 14, and 22, the dust container 50 includes a case 51 defining a closed space therein; a cover 52 provided to one side of the case 51 and having an intake port 55 and an exhaust port 56; a filter 57 provided to the exhaust port 56; a knob 53 extending from one side of the cover 52; a knob-cover 54 provided to the knob 53; and a first mounting device 80a provided to the knob 53 and the knob-cover 54 to couple the dust container 50 to the first mounting part 35.

A curved guide duct 55a is located inside the intake port 55 and extends to partially surround the filter 57.

After being sucked into the main body 30 through the body inlet 31, air is induced into the dust container 50 through the intake port 55, filtered of foreign matter by the filter 57 in the dust container 50, and is discharged again into the main body 30 through the exhaust port 56.

After being discharged into the main body 30, air is finally discharged to the outside through the body outlet 32 by the motor assembly 40.

In order to constitute an air path as described above, the first mounting part 35 is formed with a discharge port 35a corresponding to the intake port 55 and communicated with the body inlet 31, and formed with a suction port corresponding to the exhaust port 56 and communicated with the body outlet 32.

Referring to FIGS. 4, 11 and 16, the mounting device 80 includes the first mounting device 80a provided to the dust container 50, a second mounting device 80b provided to the first mounting part 35 and coupled to the first mounting device 80a, and a third mounting device 80c provided to the driving unit 60 and coupled to the first mounting device 80a.

The first mounting device 80a includes a latch protrusion 84 configured to be inserted into or protrude from the cover 52, a knob-button 82 movably provided to the knob 53 to move the latch protrusion 84 into the cover 52, and an elastic member (not shown) disposed between the latch protrusion 84 and an inner wall of the knob 53 to apply force to the latch protrusion 84 toward a groove 35c.

The second mounting device 80b includes a groove 35c formed corresponding to the latch protrusion 84 on the first mounting part 35, and the third mounting device 80c includes a groove 68 formed corresponding to the latch protrusion 84 on the driving unit 60.

Referring to FIGS. 4 and 22, a first connection device 70 is provided to the dust container 50 and the first mounting part 35. The first connection device 70 includes a circular jaw 72 extending outward from the periphery of the exhaust port 56, a sliding protrusion 74 protruding from an end of the jaw 72 in a lateral direction, a circular insertion groove 76 formed corresponding to the jaw 72 around the periphery of the suction port 35b, a catch protrusion 77 formed at an outer end of the insertion groove 76 to catch the sliding protrusion 74, and a sealing member (not shown) of an elastic material fitted into the insertion groove 76.

When mounting the dust container 50 on the first mounting part 35, the dust container 50 is inclined at a predetermined angle on the first mounting part 35 so as to prevent the sliding protrusion 74 from interfering with the catch protrusion 77, and the jaw 72 is inserted into the insertion groove 76. Then, the dust container 50 is rotated and seated on the first mounting part 35.

At this time, the sliding protrusion 74 is slid along the insertion groove 76 and is then disposed between the catch protrusion 77 and the insertion groove 76 by the rotation of the dust container 50, which leads to a close contact between the exhaust port 56 and the suction port 35b.

Further, when the dust container 50 is rotated, the elastic member (not shown) is compressed to allow the latch protrusion 84 to be inserted into the cover 52. Then, when the dust container 50 is mounted on the first mounting part 35, the latch protrusion 84 protrudes from the cover 52 by a restoration force of the elastic member and inserted into the groove 35c, thereby restricting the rotation of the dust container 50 to prevent separation of the dust container 50 from the main body 30.

The driving unit 60 is detachably mounted on the second mounting part 36 and has a suction device 61, so that when the dust container 50 is separated from the first mounting part 35, the driving unit 60 can be coupled to the dust container 50 to constitute the handy cleaner.

The driving unit 60 is provided with a suction duct 62 for sucking air, and an exhaust opening 63 for discharging air from which foreign matter is removed.

The driving unit 60 is formed with a discharge port 64 that corresponds to the intake port 55 of the dust container 50 and communicates with the suction duct 62.

The driving unit 60 is formed with a suction port 65 that corresponds to the exhaust port 56 of the dust container 50 and communicates with the exhaust opening 63.

Referring to FIGS. 5 and 11, the mounting device 80′ provided to the dust container 50 and driving unit 60 includes a latch protrusion 84′ capable of being inserted into or protruding from the surface of the cover 52, a groove 68′ formed corresponding to the latch protrusion 84′ on the driving unit 60, a knob-button 82′ movably provided to the knob 53 to allow the latch protrusion 84′ to be inserted into the cover 52 when pushed down by the user, and an elastic member (not shown) disposed between the latch protrusion 84′ and an inner wall of the knob 53 to allow the latch protrusion 84′ to be inserted into the groove 68′.

Referring to FIGS. 5 and 22, a second connection device 70′ having the same configuration as that of the first connection device 70 is provided to the dust container 50 and driving unit 60.

The second connection device 70′ includes a circular jaw 72′ extending outward from the periphery of the exhaust port 56, a sliding protrusion 74′ protruding from the end of the jaw 72′ in the lateral direction, a circular insertion groove 76′ formed corresponding to the jaw 72′ around the periphery of the suction port 65, a catch protrusion 77′ formed at the outer end of the insertion groove 76′ to catch the sliding protrusion 74′, and a sealing member (not shown) of an elastic material fitted into the insertion groove 76′.

When coupling the dust container 50, separated from the first mounting part 35, to the driving unit 60, the dust container 50 is inclined at a predetermined angle with respect to the driving unit 60 so as to prevent the sliding protrusion 74′ from interfering with the catch protrusion 77′, and the jaw 72′ is inserted into the insertion groove 76′. Then, the dust container 50 is rotated to be coupled to the driving unit 60.

At this time, the sliding protrusion 74′ is slid along the insertion groove 76′ and is then disposed between the catch protrusion 77′ and the insertion groove 76′ by the rotation of the dust container 50, which leads to a close contact between the exhaust port 56 and the suction port 65.

Further, when the dust container 50 is rotated, the elastic member (not shown) is compressed to allow the latch protrusion 84′ to be inserted into the cover 52. Then, when the dust container 50 is coupled to the driving unit 60, the latch protrusion 84′ protrudes from the cover 52 by the restoration force of the elastic member and inserted into the groove 68, thereby restricting the rotation of the dust container 50 to prevent separation of the dust container 50 from the driving unit 60.

Referring to FIGS. 18 to 21, the power supply device 90 includes a terminal 92 formed on an inner wall of the second mounting part 36 to supply electrical power, a contact point 94 formed corresponding to the terminal 92 on the driving unit 60, and a battery 96 to store electrical power supplied through the contact point 94 and to supply the electrical power to the suction device 61.

The battery 96 is received in a battery case 99, which is detachably coupled to the driving unit 60, such that the battery 96 can store electrical power supplied through the contact point 94 and supply the electrical power to the suction device 61.

A coupling device 100 is provided to the driving unit 60 and the battery case 99 to allow detachable coupling of the battery case 99 to the driving unit 60, and a coupling recess 66 is formed on the driving unit 60 to receive the battery case 99.

Referring to FIGS. 16 to 18, the coupling device 100 includes a holding groove 102 formed on the battery case 99, a lever 104 having a coupling protrusion 105 formed corresponding to the holding groove 102 at one end of the lever 104 such that the lever 104 can be hingably coupled to the coupling recess 66 of the driving unit 60, an elastic member (not shown) disposed between the lever 104 and the coupling recess 66, a connection terminal 108 provided to an inner wall of the coupling recess 66 to supply electrical power to the suction device 61, and a coupling portion 109 provided to the battery case 99 and corresponding to the connection terminal 108.

Here, since the other end of the lever is located outside the battery case 99, the coupling protrusion 105 can be separated outside the holding groove 102 by pushing the other end of the lever 104 when separating the battery case 99 from the coupling recess 66 of the driving unit 60.

When coupling the battery case 99 to the driving unit 60, the battery case 99 having a plurality of batteries 96 is inserted into the coupling recess 66. Then, the elastic member is compressed to force the coupling protrusion 105 to be pushed out of the coupling recess 66, so the battery case 99 is seated on the coupling recess 66. When the battery case 99 is inserted into the coupling recess 66, the lever 104 is rotated by the restoration force of the elastic member, allowing the coupling protrusion 105 to be inserted into the holding groove 102. As a result, the battery case 99 can be completely mounted to the driving unit 60.

Then, when the driving unit 60 is mounted on the second mounting part 36, the terminal 92 is electrically connected to the contact point 94 so that the electrical power can be stored in the batteries 96.

Referring to FIG. 25, the power supply device 90 includes a recharging printed circuit board (PCB) 98 connected in parallel to a driving PCB 98a to supply electrical power to the terminal 92.

The driving PCB 98a is a PCB to determine whether or not power is to be supplied to the motor assembly 40.

Therefore, when the driving unit 60 is mounted on the second mounting part 36 with the battery case 99 coupled to the driving unit 60, the terminal 92 is brought into contact with the contact point 94 to obtain an electrical connection therebetween.

At this time, electrical power is stored in the batteries 96 via the recharging PCB 98.

The recharging PCB 98 is connected in parallel between a power plug 97 and the driving PCB 98a. Thus, when power is applied to the driving PCB 98a by coupling the power plug 97 to a wall socket (not shown), the power is also applied to the recharging PCB 98, thereby accomplishing a charging operation.

As such, when the power plug 97 is coupled to the wall socket with the driving unit 60 mounted on the second mounting part 36, the batteries 96 can be charged irrespective of whether or not the motor assembly 40 is driven, so that the handy cleaner can be prepared for the vacuuming operation.

Additionally, since the vacuum cleaner further includes a recharger 99a connected to the battery case 99 separated from the driving unit 60 to supply electrical power, the batteries 96 can be easily charged even in the case of employing only the handy cleaner constituted by coupling the driving unit 60 to the dust container 50.

Referring to FIGS. 23 and 24, the technical constitution described above is to filter foreign matter from air by the dust container 50 when the air is sucked into the main body 30 through the body inlet 31. At this time, an extension duct (not shown) is provided to the body inlet 31, and is selectively provided at one end with one of nozzles 110, which may have various shapes, enabling effective vacuuming operations at various locations.

In order to accommodate the nozzles 110 of the various shapes, an accommodation part 34 is formed on the bottom of the main body 30 and has a plurality of accommodation grooves 39 corresponding to the shapes of the nozzles 110 on an inner wall of the accommodation part 34.

Further, to prevent the nozzles 110 from being detached from the accommodation grooves 39 of the accommodation part 34, a lid 37 is hingably coupled at one end to an edge of the accommodation part 34, and an opening-closing device 38 is provided to the other end of the lid 37 and the accommodation part 34.

The opening-closing device 38 includes a hook protrusion 38a formed on the lid 37, and a fastening groove 38b formed on the accommodation part 34 such that the hook protrusion 38a is fitted into the hook protrusion 38a.

When the hook protrusion 38a is inserted into the fastening groove 38b by rotating the lid 37 with the nozzles 110 fitted into the accommodation grooves 39, the hook protrusion 38a is suppressed from being released from the fastening groove 38b, which prevents the lid 37 from being open.

The fastening groove 38b is a typical fastening means to hold a protrusion inserted thereto in one-touch manner, and thus a detailed description thereof will be omitted herein.

When converting the vacuum cleaner constructed as above into the handy cleaner for the vacuuming operation, the dust container 50 is coupled to the driving unit 60 to constitute the handy cleaner, in which the suction duct 62 is drawably provided to the driving unit 60 to suck air and foreign matter during the vacuuming operation.

Further, when mounting the driving unit 60 and the dust container 50 on the main body 30, the suction duct 62 is located so as not to protrude from the driving unit 60, allowing the driving unit 60 and dust container 50 to be easily mounted thereon.

Such a suction duct 62 is rotatably provided to a hole 62a communicated with the discharge port 64, and is constituted by a curved pipe. Therefore, when the driving unit 60 is mounted on the second mounting part 36, the suction duct 62 is rotated so as to be brought into close contact with the lower surface of the driving unit 60 so that the driving unit 60 can be easily mounted on the second mounting part 36.

Additionally, the second mounting part 36 is formed with a curved seat groove 36a (see FIG. 19) on the bottom of the second mounting part 36 corresponding to the suction duct 62, thereby allowing easier mounting of the driving unit 60 on the main body 30.

Next, operation of the vacuum cleaner constructed as above according to an embodiment of the present invention will be described.

First, when vacuuming a large area with the vacuum cleaner, the jaw 72 is inserted into the insertion groove 76 of the first mounting part 35, with the dust container 50 slanted at a predetermined angle on the first mounting part 35. Then, by rotating the dust container 50 into the first mounting part 35, the sliding protrusion 74 is rotated along the insertion groove 76 and is then fitted between the catch protrusion 77 and the insertion groove 76, so the dust container 50 is coupled to the first mounting part 35.

Further, after being rotated downwardly and brought into close contact with the lower surface of the driving unit 60, the suction duct 62 of the driving unit 60 is inserted into the seat groove 36a on the second mounting part 36, allowing the driving unit 60 to be mounted on the second mounting part 36 with the terminal 92 electrically connected to the contact point 94.

With the dust container 50 and driving unit 60 mounted on the main body of the vacuum cleaner as described above, the power plug 97 is pulled out of the main body 30 and connected to a wall socket to supply electrical power to the driving PCB 98a and the recharging PCB 98, thereby charging the batteries 96.

Of course, even in a state where the driving unit 60 is not mounted on the second mounting part 36, the vacuum cleaner can be driven since power is applied to the motor assembly 40.

Then, when a user starts vacuum cleaning, power is supplied from the driving PCB 98a to the motor assembly 40 to generate a suction force, which causes air to be induced through one of the nozzles 110 and the extension duct (not shown).

After being induced into the main body 30 through the body inlet 31, air flows into the dust container 50 along the discharge port 35a, intake port 55, and a guide duct 55a.

After being induced into the dust container 50, air flows from the periphery of the filter 57 to the center thereof, during which foreign matter is removed from the air by the filter 57.

The air filtered of the foreign matter flows again to a flow passage 32a defined at the central region of the main body 30 through the exhaust port 56 and suction port 35b.

In this manner, as air is discharged from the main body 30 through the body outlet 32 via the motor assembly 40, the vacuuming operation of the vacuum cleaner can be performed.

With such an operation as described above, the vacuum cleaner is used to vacuum the large area.

Next, when vacuuming narrow areas such as a gap between pieces of furniture, a channel of a door, etc., it can be accomplished by preparing the handy cleaner after separating the dust container 50 and the driving unit 60 from the main body 30.

When the user pushes down the knob-button 82 to constitute the handy cleaner, the elastic member (not shown) is compressed to allow the latch protrusion 84 to be inserted into the knob-cover 54. Then, by rotating the knob 53 upwardly with the knob-button 82 pushed down, the dust container 50 is rotated and the sliding protrusion 74 is released from the catch protrusion 77.

As a result, the dust container 50 can be separated from the first mounting part 35.

Then, the separated dust container 50 is connected to the driving unit 60 separated from the second mounting part 36 as in the manner of connecting the dust container 50 to the first mounting part 35, thereby constituting the handy cleaner.

Finally, by rotating the suction duct 62 closely contacting the lower surface of the driving unit 60 forwardly, the hole 62a of the driving unit 60 formed corresponding to the suction duct 62 is connected to the suction duct 62, and the suction duct 62 is thus communicated with the discharge port 64.

When turning on the power switch 67 of the handy cleaner constituted as described above, the suction device 61 is driven to force air to be sucked into the handy cleaner along the suction duct 62, and the sucked air flows into the dust container 50 through the discharge port 64 and intake port 55.

After being induced into the dust container 50, air flows from the periphery of the filter 57 to the center thereof, during which foreign matter is removed from the air by the filter 57.

The air filtered of the foreign matter flows again to the driving unit 60 through the exhaust port 56 and suction port 65, and is then discharged from the driving unit 60 through the exhaust opening 63 via the suction device 61.

In this manner, the vacuuming operation of the handy cleaner is performed.

In order to allow the vacuuming operation of the handy cleaner to be performed for a long period of time, the batteries 96 is recharged.

First, the dust container 50 is separated from the driving unit 60 as in the method of separating the dust container 50, and the separated driving unit 60 is mounted on the second mounting part 36.

As a result, the terminal 92 is brought into contact with and electrically connected to the contact point 94, electrical power is supplied from the recharging PCB 98 to the driving unit 60, and thereby charges the batteries 96.

In order to charge the batteries 96 without separating the driving unit 60 from the dust container 50, the lever 104 is pushed down to allow the coupling protrusion 105 to be released from the holding groove 102.

Next, after taking the battery case 99 out of the driving unit 60, the charging operation of the batteries 96 can be performed by connecting the recharger 99a to the coupling portion 109.

The handy cleaner-integrated vacuum cleaner according to an embodiment of the present invention has been described above. However, it should be noted that the present invention is not limited to this embodiment of the vacuum cleaner. For example, a vacuum cleaner can be constituted by the main body 30, the motor assembly 40, and the dust container 50 without the driving unit 60, and can be used to perform the vacuuming operation of the vacuum cleaner described above.

Further, a handy cleaner can be constituted by a driving unit 60, a dust container 50 and a recharger 99a without the main body 30 and the motor assembly 40 of the vacuum cleaner according to an embodiment of the invention, and can be used to perform the vacuuming operation of the handy cleaner described above.

Such a handy cleaner includes the dust container 50 having an intake port 55 and an exhaust port 56, and a filter 57 located inside the dust container 50; the driving unit 60 detachably attached to the dust container 50 to generate a suction force in the dust container 50; a suction duct 62 provided to the driving unit 60 and communicated with the intake port 55; and an exhaust opening 63 formed in the driving unit 60 and communicated with the exhaust port 56.

The filter 57 has a cylindrical shape and is located inside the exhaust port 56. The intake port 55 extends to partially surround the filter 57 as shown in FIGS. 11 and 15.

A curved guide duct 55a is located inside the intake port 55 of the dust container 50 and extends to partially surround the filter 57.

With the handy cleaner including a cyclone type dust container constructed as described above, it is possible to perform vacuuming operation as in the handy cleaner according to an embodiment of the invention described above.

As apparent from the above description, in the vacuum cleaner according to an embodiment the present invention, a dust container is detachably mounted at one side of a linear air path to provide an efficient flow of air, thereby improving blowing efficiency.

Further, the handy cleaner-integrated vacuum cleaner according to an embodiment the invention is configured to allow convenient detachment and mounting of the dust container such that the dust container is detached from the vacuum cleaner to constitute a handy cleaner to perform vacuum cleaning of a narrow space as well as a wide space, and has a separate accommodation space to accommodate various components such as nozzles, spare filters, and the like, thereby improving convenience of a user.

Although embodiments of the present invention has been described with reference to and the accompanying drawings, it will be apparent to those skilled in the art that an embodiments are given by way of illustration, and that various modifications and equivalent embodiments can be made without departing from the spirit and scope of the present invention.

Further, although the handy cleaner-integrated vacuum cleaner has been described, this vacuum cleaner is given by way of one example, and the dust container, driving unit and main body according to an embodiment of the present invention can be applied to other vacuum cleaners.

What is claimed is:

1. A method of vacuum cleaning, the method comprising:
providing a vacuum cleaner device comprising a main body, a first member releasably secured to the main body, a second member releasably secured to the main body, and a suction hose connected to the main body, wherein the main body comprises a first suction source, wherein the first member comprises a first housing and a dust container defined by or enclosed in the first housing, wherein the dust container is in fluid communication with the first suction source, wherein the second member comprises a second housing and a second suction source enclosed in the second housing, wherein the dust container is not in fluid communication with the second suction source, wherein the suction hose is in fluid communication with the dust container of the first member; and
running the first suction source so as to create a negative pressure in the dust container and in the suction hose, thereby cleaning a surface.

2. The method of claim 1, further comprising:
releasing the first member from the main body;
releasing the second member from the main body; and
engaging the first housing and the second housing to assemble a handheld vacuum cleaner such that the dust container and the second suction source are in fluid communication.

3. The method of claim 2, wherein the handheld vacuum cleaner comprises an air intake tube in fluid communication with the dust container, wherein the method further comprises running the second suction source so as to create airflows from the air intake tube to the dust container and from the dust container to the suction source, thereby cleaning a surface.

4. The method of claim 3, wherein outside air is drawn into the air intake tube and flows to the dust container generally in a first direction, wherein air in the dust container flows to the suction source generally in a second direction, which crosses the first direction when viewed from the top of the handheld vacuum cleaner.

5. The method of claim 4, wherein the first and second direction cross at about a right angle.

6. The method of claim 3, wherein the second housing defines a conduit interconnecting between the air intake tube and the dust container of the first member, wherein the outside air drawn into the air intake tube flows through the conduit of the second housing to reach the dust container.

7. The method of claim 6, wherein the air intake tube is hingedly connected to the second housing, and wherein the method further comprises hingedly rotating the air intake tube between a first position and a second position.

8. The method of claim 2, wherein the first member is released from the main body without use of a tool.

9. The method of claim 2, further comprising:
disengaging the first member from the second member;
securing the first member to the main body such the dust container is in fluid communication with the first suction source; and
securing the second member to the main body.

10. The method of claim 9, wherein securing the first member to the main body does not require a tool.

11. The method of claim 1, wherein the main body further comprises a storage compartment and further comprises at least one of a nozzle and an extension tube stored in the storage compartment, wherein the method further comprises connecting at least one of the nozzle and the extension tube to the suction hose.

12. The method of claim 1, wherein the vacuum cleaner device is a canister type vacuum cleaner.

13. The method of claim 1, wherein the first member comprises partitioning walls configured to generate a swirling airflow within the dust container.

14. The method of claim 1, wherein the first housing comprises a first inlet and a first outlet, wherein the dust container is positioned in a path between the first inlet and the first outlet, wherein the main body comprises a first suction passage and a second suction passage, wherein the first suction passage is in fluid communication with the dust container via the first inlet, and the first suction source and the first outlet are in fluid communication via the second suction passage.

15. A method of vacuum cleaning, comprising:
providing a first member comprising a first housing and a dust container defined by or enclosed in the first housing;
providing a second member comprising a second housing and a suction source enclosed in the second housing;
engaging the first and second members so as to form a single body handheld vacuum cleaner, in which the dust container and the suction source are in fluid communication with each other, wherein the handheld vacuum cleaner comprises an air intake tube in fluid communication with the dust container; and
running the suction source so as to create airflows from the air intake tube to the dust container and from the dust container to the suction source, wherein outside air is drawn into the air intake tube and flows to the dust container generally in a first direction, wherein air in the dust container flows to the suction source generally in a second direction, which crosses the first direction when viewed from the top of the handheld vacuum cleaner.

16. The method of claim 15, wherein the first and second direction cross at about a right angle.

17. The method of claim 15, wherein the handheld vacuum cleaner further comprises an elongated handle, wherein when viewed from the top, the first housing is generally on one side of the elongated handle and the second housing is generally on the other side of the elongated handle.

18. The method of claim 15, wherein the elongated handle is fixed to the first housing.

19. The method of claim 15, wherein the second housing defines a conduit interconnecting between the air intake tube and the dust container of the first member, wherein the outside air drawn into the air intake tube flows through the conduit of the second housing to reach the dust container.

20. The method of claim 15, wherein the first member comprises partitioning walls configured to generate a swirling airflow within the dust container.
